(19) United States
(12) Patent Application Publication
(10) Pub. No.: US 2009/0059255 A1
(43) Pub. Date: Mar. 5, 2009

(54) IMAGE PROCESSING APPARATUS, IMAGE FORMING APPARATUS, AND IMAGE PROCESSING METHOD

(76) Inventor: Toshio OHIDE, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/199,917

(22) Filed: Aug. 28, 2008

(30) Foreign Application Priority Data
Sep. 5, 2007 (JP) 2007-230366
Jul. 28, 2008 (JP) 2008-193292

(51) Int. Cl. G06F 15/00

(52) U.S. Cl. 358/1.9

(57) ABSTRACT

A dividing unit divides image data that is formed with a plurality of pixels each including an image dot in a main scanning direction and a sub scanning direction in units of pixel, and divides a target pixel, which is a pixel to be corrected from among divided pixels, into a plurality of image blocks including a plurality of image dots. A correcting unit corrects the image dots of the image blocks, based on contrast of densities of adjacent pixels adjacent to the target pixel, by shifting the image dots in a density direction that is a direction toward an adjacent pixel having a higher density.

### CROSS-REFERENCE TO RELATED APPLICATIONS

The present application claims priority to and incorporates by reference the entire contents of Japanese priority documents, 2007-230366 filed in Japan on Sep. 5, 2007 and Japanese priority document 2008-193292 filed in Japan on Jul. 28, 2008.

### BACKGROUND OF THE INVENTION

1. Field of the Invention

The present invention relates to a technology for forming an image, and more specifically to a technology for providing a super fine image by controlling positions of dots that form the image.

2. Description of the Related Art

In forming an image based on the electrophotography, increase of throughput rate and improvement of image quality are demanded. As photolithographic technique improves enabling microfabrication with a finer pitch, semiconductor lasers become widely used, which include a single semiconductor chip that can emit a plurality of laser beams. This means an increase of semiconductor laser beams per unit area, and therefore a size of dots irradiated on a photoreceptor drum can be decreased, thereby forming a finer image at a higher speed.

In forming an image that includes halftone using the electrophotography, an electrical static charge of an isolated dot with lower density is relatively unstable. This may decrease reproductivity of the halftone formed by area coverage modulation, resulting in degradation of the image quality.

Therefore, conventionally, so as not to produce such an isolated dot with lower density, the tone of the isolated dot is shifted closer to the tone of the denser of two adjacent pixels in a main scanning direction.

As the semiconductor laser becomes capable of forming an electrostatic latent image with finer dots, a dot that should not be conventionally isolated can be generated as an isolated dot. However, depending on the position of the dot, the tone of the dot can be shifted closer to that of adjacent pixels in a sub scanning direction in addition to the main scanning direction.

An image forming processing in consideration of pixels surrounding a target pixel to be irradiated with a laser is disclosed in, for example, Japanese Patent Application Laid-open No. 2004-336487.

In the conventional technology described above, a modulation transfer function of an image that includes the target pixel is controlled by performing a filtering processing, but neither by generating an isolated dot nor by shifting the tone of the generated isolated dot. Furthermore, a technology for preventing degradation of the image quality by processing the dot that should conventionally be treated as an isolated dot using a multi-beam semiconductor laser is not disclosed in Japanese Patent Application Laid-open No. 2004-336487.

### SUMMARY OF THE INVENTION

It is an object of the present invention to at least partially solve the problems in the conventional technology.

According to an aspect of the present invention, there is provided an image processing apparatus including a dividing unit that divides image data that is formed with a plurality of pixels each including an image dot in a main scanning direction and a sub scanning direction in units of pixel, and divides a target pixel, which is a pixel to be corrected from among divided pixels, into a plurality of image blocks including a plurality of image dots; and a correcting unit that corrects the image dots of the image blocks, based on contrast of densities of adjacent pixels adjacent to the target pixel, by shifting the image dots in a density direction that is a direction toward an adjacent pixel having a higher density.

Furthermore, according to another aspect of the present invention, there is provided an image processing apparatus including a reading unit that reads an original, and generates image data that is formed with a plurality of pixels each including an image dot; a dividing unit that divides the image data in a main scanning direction and a sub scanning direction in units of pixel, and divides a target pixel, which is a pixel to be corrected from among divided pixels, into a plurality of image blocks including a plurality of image dots; and a correcting unit that corrects the image dots of the image blocks, based on contrast of densities of adjacent pixels adjacent to the target pixel, by shifting the image dots in a density direction that is a direction toward an adjacent pixel having a higher density.

Moreover, according to still another aspect of the present invention, there is provided an image processing method including dividing image data that is formed with a plurality of pixels each including an image dot in a main scanning direction and a sub scanning direction in units of pixel, and divides a target pixel, which is a pixel to be corrected from among divided pixels, into a plurality of image blocks including a plurality of image dots; and correcting the image dots of the image blocks, based on contrast of densities of adjacent pixels adjacent to the target pixel, by shifting the image dots in a density direction that is a direction toward an adjacent pixel having a higher density.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an image forming apparatus according to a first embodiment of the present invention;

FIG. 2 is a block diagram of a laser control unit included in the image forming apparatus;

FIG. 3 is a schematic diagram for explaining laser emission from a semiconductor laser array or a vertical cavity surface emitting laser;

FIG. 4 is a schematic diagram for explaining image sections divided by a pixel dividing unit shown in FIG. 2;

FIG. 5 is a schematic diagram for explaining tone shifting patterns of dots in a target pixel;

FIG. 6 is a schematic diagram for explaining a process of assigning an address to the dots;

FIG. 7 is a schematic diagram for explaining a set of the tone shifting patterns stored in a register memory shown in FIG. 2;

FIG. 8 is a schematic diagram for explaining an n-ary operation process performed in the first embodiment;

FIG. 9 is a flowchart of a tone shifting process performed by a controller shown in FIG. 2;

FIG. 10 is a schematic diagram for explaining a relation between rotation of the tone shifting pattern and assignment of a virtual address at which the flag is set;

FIG. 11 is a schematic diagram for explaining another example of the relation between the rotation of the tone shifting pattern and the assignment of the virtual address at which the flag is set;

FIG. 12A is a sequence diagram of an n-ary operation routine performed in a process shown in FIG. 10; and

FIG. 12B is a sequence diagram of the n-ary operation routine performed in the process shown in FIG. 11.

### DETAILED DESCRIPTION OF THE PREFERRED EMBODIMENTS

Exemplary embodiments of the present invention are described in detail below with reference to the accompanying drawings. The present invention is not limited to the embodiments, and various modifications can be made without departing from the scope of the invention.

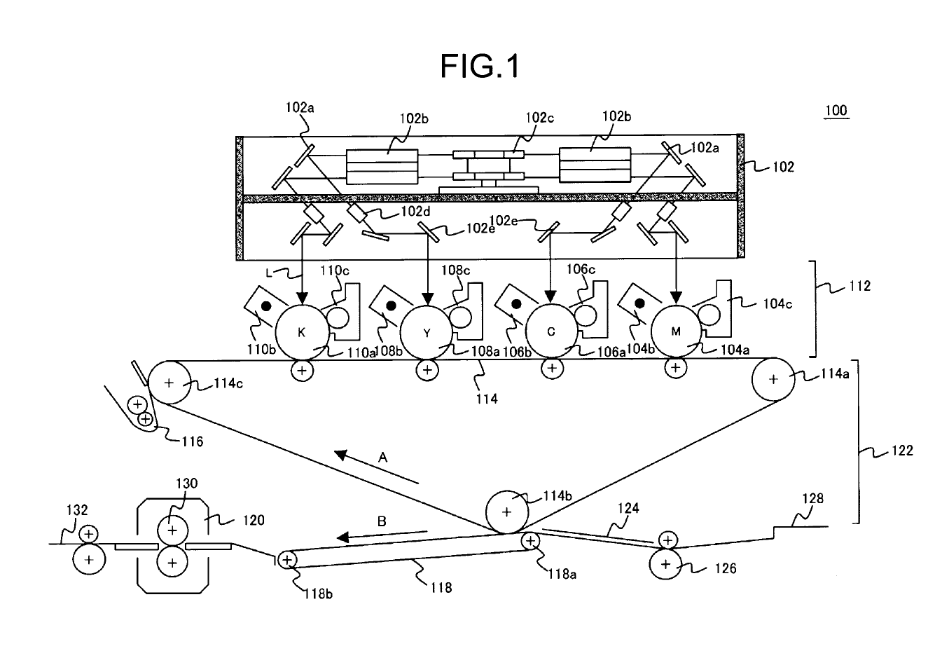

FIG. 1 is a schematic diagram of an image forming apparatus 100 according to a first embodiment of the present invention. The image forming apparatus 100 receives an image data from another apparatus, such as a scanner, that includes a charge coupled device (CCD) and the like, and controls a semiconductor laser and a conveyance system according to the image data, thereby forming an image.

The image forming apparatus 100 includes an optical unit 102 including optical devices such as a semiconductor laser and a polygon mirror, an image forming unit 112 including photoreceptor drums, chargers, developing units, and the like, and a transfer unit 122 including an intermediate transfer belt and the like.

In the optical unit 102, the semiconductor laser emits beams. The beams are polarized by a polygon mirror 102c, enter fθ lenses 102b, and then they are reflected by reflecting mirrors 102a. The number of the beams is equal to the number of colors used in the image forming, i.e., cyan (C), magenta (M), yellow (Y), and black (K) according to the first embodiment. As the semiconductor laser, a vertical cavity surface emitting laser (VCSEL), which includes a single semiconductor chip that can emit a plurality of laser beams, is used to emit the laser beams in a main scanning direction and a sub scanning direction.

Wide toroidal lenses (WTL) 102d reform and polarize the beams toward reflecting mirrors 102e. The reflecting mirrors 102e reflect the beams onto photoreceptor drums 104a, 106a, 108a, and 110a. The reflected beams form images on the photoreceptor drums 104a, 106a, 108a, and 110a for exposure, and these beams for the exposure are hereinafter referred to as beams L. Because a plurality of the optical devices is used to generate the beams L, timing synchronization is performed in both the main scanning direction and the sub scanning direction. Hereinafter, the main scanning direction is defined as a direction in which beams run, and the sub scanning direction is defined as a direction orthogonal to the main scanning direction, i.e., the direction in which the photoreceptor drums 104a, 106a, 108a, and 110a rotate in the image forming apparatus 100.

The photoreceptor drum 104a includes a drum made of a conductive material, such as aluminum, formed with a photoconductive layer that includes at least a charge generating layer and a charge transfer layer. The photoreceptor drums 106a, 108a, and 110a have the same configurations as the photoreceptor drum 104a. The image forming unit 112 includes chargers 104b, 106b, 108b, and 110b corresponding to the photoreceptor drums 104a, 106a, 108a, and 110a, each including a corotron, a scorotron, or a roller charging device. The chargers 104b, 106b, 108b, and 110b apply surface charge to the photoconductive layers.

Static charge applied onto the photoreceptor drums 104a, 106a, 108a, and 110a by the chargers 104b, 106b, 108b, and 110b is exposed to the beams L so that electrostatic latent images are formed. The electrostatic latent images formed on the photoreceptor drums 104a, 106a, 108a, and 110a are developed by developing units 104c, 106c, 108c, and 110c, each including a developing sleeve, a developer supplying roller, a control blade, and the like.

Developers held on the photoreceptor drums 104a, 106a, 108a, and 110a is transferred onto an intermediate transfer belt 114, which is conveyed by conveyance rollers 114a, 114b, and 114c in a direction indicated by an arrow A. The intermediate transfer belt 114 is conveyed to a secondary transfer unit as it holds the developers of C, M, Y, and K. The secondary transfer unit includes a secondary transfer belt 118 and conveyance rollers 118a and 118b. The secondary transfer belt 118 is conveyed by the conveyance rollers 118a and 118b in a direction indicated by an arrow B. The secondary transfer unit is supplied with a printing material 124, such as a quality paper sheet and a plastic sheet, from a printing material container 128, such as a paper feed cassette.

The secondary transfer unit applies a secondary-transfer bias voltage so that a multicolor developer is transferred from the intermediate transfer belt 114 to the printing material 124 adsorptively retained by the secondary transfer belt 118. The printing material 124 is then conveyed to a fixing unit 120. The fixing unit 120 includes fixing members, such as a fixing roller made of silicone rubber or fluororubber. The fixing unit 120 applies heat and pressure to the printing material 124 and the multicolor developer to produce a printed material 132, and conveys the printed material 132 to the outside of the image forming apparatus 100. After the transfer of the multicolor developer, the intermediate transfer belt 114 is cleaned of remaining developer by a cleaning unit 116 that includes a cleaning blade, and then used in the following process of image forming.

Although the image forming apparatus 100 shown in FIG. 1 is a full-color copier, the image forming apparatus according to the first embodiment can be a so-called multifunction device that includes a copier, a facsimile, a printer, a scanner, and a network connection, in either full color or monochrome.

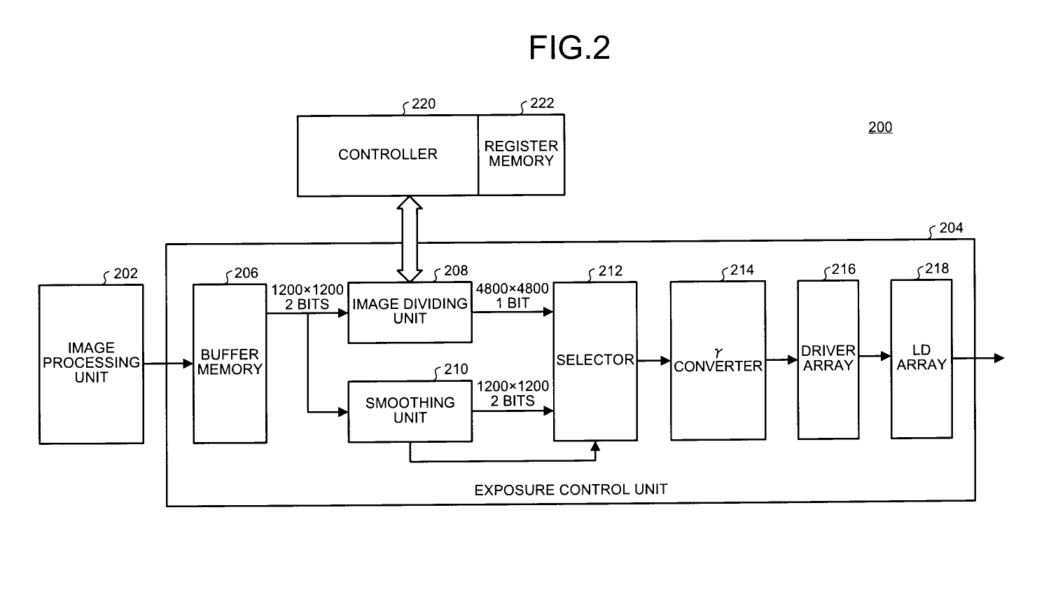

FIG. 2 is a block diagram of a laser control unit 200 included in the image forming apparatus 100. The image forming apparatus 100 further includes an image processing unit 202 that digitalizes an analogue image received from the scanner or the like, and outputs the digital image to the laser control unit 200. The laser control unit 200 forms the electrostatic latent image of the digital image on the photoreceptor drums 104a, 106a, 108a, and 110a using a laser diode (LD) array 218 that includes the VCSEL and the like. The laser control unit 200 includes a controller 220 and an exposure control unit 204. The controller 220 is configured as a microcomputer, such as an application specific integrated circuit (ASIC). The laser control unit 200 controls the overall image processing performed in the image forming apparatus 100.

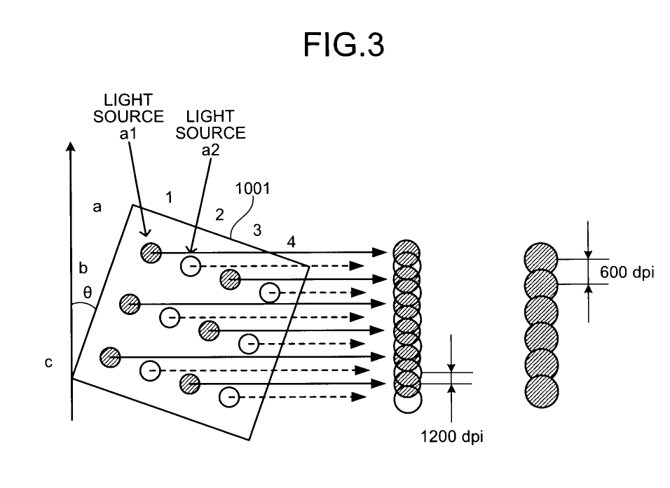

There are various technologies that use the VCSEL in an image forming apparatus. For example, as shown in FIG. 3, in a writing optical system included in a typical image forming apparatus, a light source unit 1001 includes either one of a semiconductor laser array including a plurality of semiconductor arrays in a lattice-like arrangement, and a VCSEL including a plurality of the VCSELs in a single chip. An angle of the light source unit 1001 is adjusted so that an array of the light sources tilts at a predetermined angle of θ° to a rotation axis of the deflector such as the polygon mirror.

In FIG. 3, rows of the light sources are symbolized by a, b, and c, and columns of the light sources are symbolized by 1 to 4, thereby expressing, for example, a top left light source as a light source a1. Because of the angle, the light source a1 and a light source a2 irradiates different scanning lines. Assume that two light sources form a single pixel. The light sources a1 and a2 form a pixel, and light sources a3 and a4 form another pixel. When the sub scanning direction runs in a longitudinal direction of FIG. 3, a distance between centers of adjacent pixels is 600 dpi, and a distance between centers of beams emitted from adjacent light sources that form a single pixel is 1200 dpi, which means the density of the light sources is two times higher than the density of the pixels. Therefore, by changing a ratio between the two light sources, a barycentric position of the pixel can be shifted in the sub scanning direction, thereby forming a fine image.

Returning to FIG. 2, the controller 220 performs control to allocate dots to image sections divided by an image dividing unit 208 to be explained later. The controller 220 includes a storing unit, such as a register memory 222, a read only memory (ROM) (not shown), and an erasable programmable read only memory (EPROM) (not shown), and executes a computer program to perform such processes as tone shifting. Furthermore, the controller 220 communicates with the exposure control unit 204 by a serial communication to receive a result of the process by the image dividing unit 208 and perform the tone shifting. The controller 220 either registers a data of the dots generated by the tone shifting in a format usable for the image dividing unit 208 or sends the data to the image dividing unit 208, generating a dot pattern of a target pixel. Although the controller 220 is independent from the exposure control unit 204 in FIG. 2, the controller 220 and the exposure control unit 204 can be integrated.

Moreover, the controller 220 saves a predetermined memory area of the register memory 222 to store therein tone shifting patterns. Upon receiving a request for the tone shifting from the image dividing unit 208, the controller 220 acquires densities of the target pixel, to which dots are allocated, and pixels adjacent to the target pixel to start the tone shifting processing.

The exposure control unit 204 includes a buffer memory 206 based on a first-in first-out (FIFO) scheme. The buffer memory 206 receives a 2-bit signal indicative of a 1200×1200 dpi pixel from the image processing unit 202 and stores the data with an amount corresponding to a plurality of main scanning lines, and, upon request for reading from a downstream data-processing unit (not shown), outputs the data to the downstream data-processing unit. At this stage, the image data is described by 2-bit signals indicative of 1200×1200 dpi pixels.

The data output from the buffer memory 206 is then input to the image dividing unit 208 and a smoothing unit 210. The image dividing unit 208 divides the 1200×1200 dpi pixel indicated by the 2-bit signal into 4800×4800 dpi pixels. The 2-bit signal is used to indicate tones of the pixel, where, for example, 00 indicates a density corresponding to white, 11 indicates a density corresponding to black, and 01 and 10 indicate densities of halftones.

The image dividing unit 208 generates a signal pulse train indicative of 4800×4800 dpi pixels corresponding to a 1200×1200 dpi pixel with reference to an image flag, and inputs the signal pulse train to a selector 212. The image flag indicates a pattern of the 4800×4800 dpi pixels used to reproduce the density of the 1200×1200 dpi pixel.

The smoothing unit 210 acquires the image data from the buffer memory 206 with an amount of for example, nine scanning lines each in the main scanning direction and the sub scanning direction, and checks bit values of the image data. As a result of the check, if the image data does not include a halftone that forms a character or a line drawing, the smoothing unit 210 performs a smoothing processing, such as an edge processing, in units of the acquired area, and outputs the processed 2-bit data in units of 1200×1200 dpi pixels to the selector 212.

Furthermore, if the image data does not include the halftone, the smoothing unit 210 asserts a select signal, and inputs the select signal to the selector 212. While the select signal is asserted, the selector 212 outputs the 2-bit data in units of 1200×1200 dpi pixels to the downstream data-processing unit. While the select signal is not asserted, the selector 212 outputs 1-bit data in units of 4800×4800 dpi pixels to form a super fine image.

By branching the process performed on the 2-bit signals output from the buffer memory 206, the exposure control unit 204 can easily switch resolutions of the image even if the image type suddenly changes from the character or the line drawing to the halftone image, because the image dividing unit 208 computes values of super fine dots to be output at the same time.

The signals output from the selector 212 are input to a γ converter 214. The γ converter 214 generates a signal pulse train at an output level corresponding to lasing characteristics of the LD array 218, and outputs the signal pulse train to a driver array 216. The driver array 216 generates a drive-signal pulse train using pulse width modulation signals or the like. The drive-signal pulse train from the driver array 216 drives the semiconductor laser included in the LD array 218, which is incorporated as the VCSEL, so that the semiconductor laser emits laser beams onto the photoreceptor drums to form the electrostatic latent image.

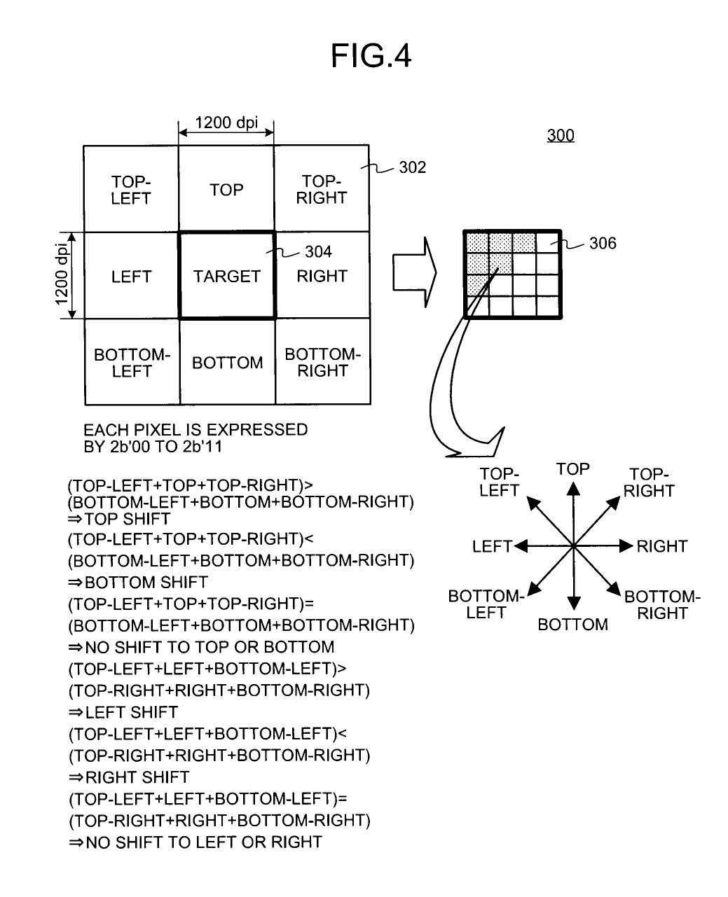

FIG. 4 is a schematic diagram for explaining image sections divided by the image dividing unit 208. The image dividing unit 208 divides a target image area 300 into nine pixels 302 including a target pixel 304. The nine 1200-dpi pixels are used as a unit in the following steps. The image dividing unit 208 further divides the target pixel 304 into four sections each in the main scanning direction and the sub scanning direction, and assigns 4800×4800 dpi pixels 306.

Each of the pixels 306 is assigned with a unique address to set a flag in the register memory 222. The flag is used to determine whether a command should be issued to set a toned dot to the pixel 306. The controller 220 performs control of setting the flags to the pixels 306, thereby reproducing a density given by the 2-bit data of the target pixel 304.

If the 2-bit signal is 2′b00 indicative of white, the flag is not set at any one of the pixels 306. If the 2-bit signal is 2′b11 indicative of black, the flag is set at all of the pixels 306. If the 2-bit signal is 2′b01 or 2′b10 indicative of halftone, the flag is set at an appropriate ratio that reproduces the density similar to that of the adjacent pixel.

According to the first embodiment, the pattern of the 4800×4800 dpi super fine dot is formed by setting tones similar to the adjacent pixel so that the super fine dot is not isolated. This process is herein referred to as a tone shifting process. According to the first embodiment, because a plurality of laser beams can be generated in a single main scanning line of 1200 dpi, the tone shifting process can be performed not only in the main scanning direction but also in the sub scanning direction, thereby enabling an optimal tone shifting process in two-dimensional directions.

As described above, nine pixels including the target pixel 304 and eight adjacent pixels are used in the tone shifting process. The image dividing unit 208 sends image data of the nine pixels to the controller 220. The controller 220 adds up the densities of the adjacent pixels in each of two rows and two columns avoiding the target pixel 304, thereby determining the density of each row or column. The controller 220 then compares the densities of each row or column, determine the direction in which the tone should be shifted, and sets the direction in a tone-shifting direction data.

In this case, the controller 220 generates the tone-shifting direction data as an 8-bit data corresponding to directions of the eight adjacent pixels, and stores the tone-shifting direction data in the register memory 222. In the tone-shifting direction data, for example, but not limited to, the upper bit indicates a top-left shift and the lower bit indicates a bottom-right shift. The controller 220 then sets the flag at the address so that the tone shifting pattern is given according to the tone-shifting direction data. An example of setting the flag will be explained later.

The format of the tone-shifting direction data is not limited. However, in the following explanation, 16 tone shifting patterns can be generated from the minimum tone shifting patterns stored in the register memory using the 8-bit data.

The image dividing unit 208 generates a signal pulse train corresponding to the set flag and the address at which the flag is set, and generates the 4800×4800 dpi image data input to the selector 212. An example of the process of determining the tone shifting direction is shown in FIG. 4. In any one of top shift, bottom shift, right shift, left shift, top-right shift, top-left shift, bottom-right shift, and bottom-left shift can be determined by the comparison of the tones of the rows and the columns. For example, if the tone should be shifted to both top and left, the tone shifting direction is determined as the top-left shift.

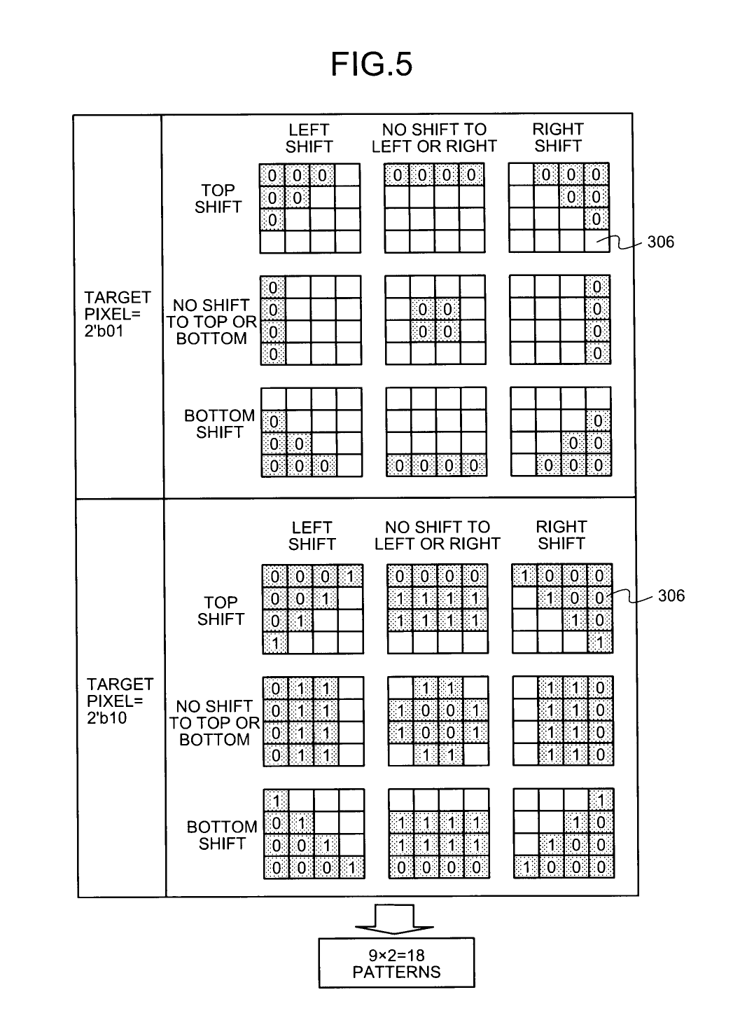

FIG. 5 is a schematic diagram for explaining the tone shifting patterns of setting the flags at the dots in the target pixel 304. The tone shifting pattern is configured as a pattern of the pixels 306, i.e. dots, at which the flag is set. The dots are arranged so that the density of the target pixel 304 is virtually reproduced.

If the density of the target pixel 304 is 2′b10, it is determined that about two thirds of the dots should be set with the flag, and there are tone shifting patterns for 2′b10 corresponding to the tone shifting direction. The number shown in each of the pixels 306 is the most significant bit in the cases of 2′b01 and 2′b10. If the density of the target pixel 304 is 2′b01, it is determined that about one third of the dots should be set with the flag.

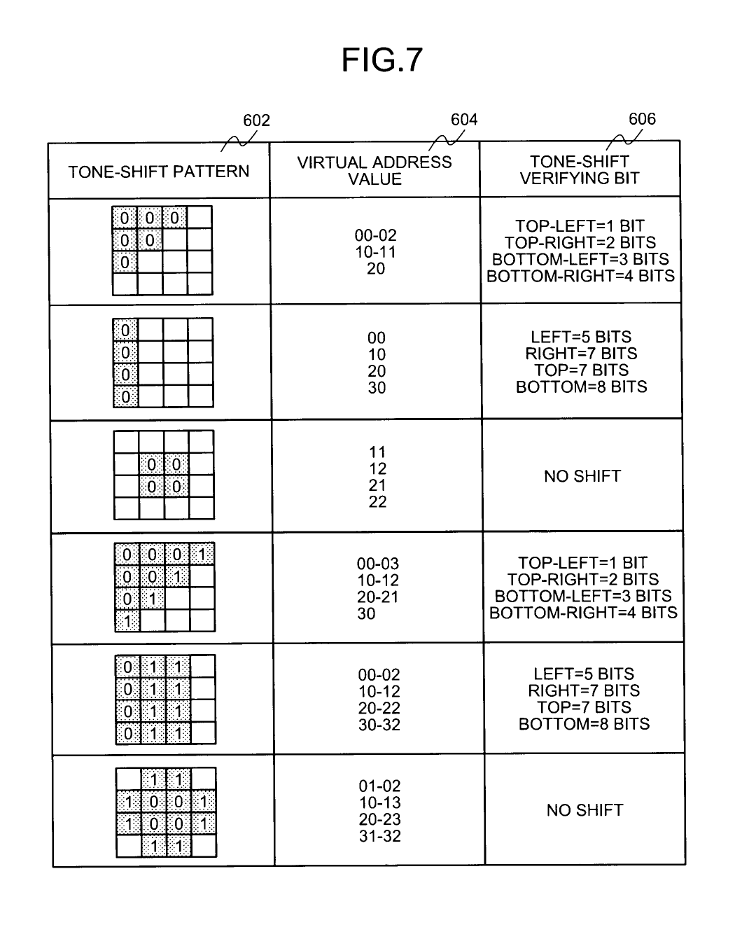

As shown in FIG. 5, there are nine patterns including a no shift pattern for each halftone level, i.e., 18 patterns in total. In a preferable example of the first embodiment, instead of storing all of the 18 patterns, for example, a minimum set of tone-shifting patterns shown in FIG. 7 is stored in the register memory 222. The controller computes the position of the pixel 306, at which the flag needs to be set, according to a required rotation or shift of the stored tone shifting pattern, and sets the flag accordingly. Because the tone shifting direction is determined while rotating or shifting the stored tone shifting pattern, the image quality is not degraded by an isolated dot regardless of the orientation of the input image data.

Because the controller 220 stores the minimum set of the tone shifting patterns, the memory area used in the register memory 222 is reduced, and the controller 220 computes the address of the dot by a bit operation without reference to a lookup table or the like, which does not require an input/output access. As a result, the throughput rate is as high as the clock cycle of the controller 220.

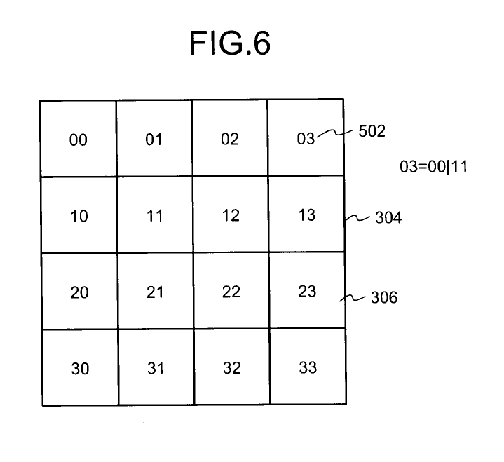

FIG. 6 is a schematic diagram for explaining a process of assigning the address to the dots in the target pixel 304. Although the address can be assigned using a real address in the register memory 222, in view of the throughput rate, it is preferable to assign a virtual address to the dot and map the real address to the virtual address. The process of assigning the virtual address is explained below.

The image dividing unit 208 divides the 1200×1200 dpi target pixel 304 into 16 pixels 306. At this stage, the flags are not set at the real address of the pixels 306. The pixel 306 that is or should be set with the flag is herein referred to as a dot, and it is hatched in the drawings.

It is preferable to use a numeral system using the number that divides the pixel as the radix, which is a positive integer equal to or more than two, so that the pixel 306 corresponding to the rotation of the tone shifting pattern can be computed at a high speed. The image dividing unit 208 can store the 4×4 fixed virtual addresses in the register memory 222. Furthermore, so as to cope with an increase and a decrease of the dividing number or the number of the laser beam by the minimum correction in the controller 220, the image dividing unit 208 can store the dividing number of the virtual address in the register memory 222 and produce a carry in each row of the image sections. In this manner, the image processing can easily cope with the change of the dividing number or the number of the laser beam without an increase of the memory area or a drastic correction of the programming, thereby enabling more flexible processing.

A real address, at which the flag is set in the register memory 222, is mapped to the virtual address, so that the flag can be set at the real address corresponding to the rotation of the tone shifting pattern. In the example shown in FIG. 6, the 16 addresses are expressed by a quaternary number for convenience. The pixels are assigned with 00, 01, 02, and 03 from the top left to the top right, and the last pixel at the bottom right is assigned with 33 in the quaternary numeral system, which is equal to 1111 in the binary numeral system.

Although the virtual address is expressed by the quaternary number in the drawings, the same solution is obtained even if the virtual address is expressed by the binary number and using the upper two digits and the lower two digits as individual digits. In this manner, the n-ary numeral system can be set in consideration of the computing efficiency and the dividing number of the target pixel 304. For example, in FIG. 6, a virtual address 03 assigned to a dot 502 is expressed in the quaternary numeral system, which is 00|11 in the binary numeral system. In the case of the binary numeral system, the upper two digits and the lower two digits are subject to the binary operation separately, as divided by a symbol |.

FIG. 7 is a schematic diagram for explaining a set of the tone shifting patterns stored in the register memory 222. The set is stored in the ROM or the like administered by the controller 220, and the set is stored at an address allocated in the register memory 222 when the controller 220 gets started. The register memory 222 includes a memory area 602 used to store the minimum set of the tone shifting patterns. The register memory 222 further includes a memory area 604 corresponding to the memory area 602, which is used to store the virtual address of the pixel 306 at which the flag should be set based on the corresponding tone shifting pattern. Moreover, the register memory 222 includes a memory area 606 set with check bits in units of eight bits for determining the tone shifting direction. In short, the register memory 222 includes the memory areas 602, 603, and 606.

The controller 220 generates the tone-shifting direction data by setting a value indicative of the tone shifting direction at the corresponding address, after determining the tone shifting direction. The tone-shifting direction data is not limited to the 8-bit data; it can be generated in any unit depending on the types or the number of the tone shifting patterns stored as the minimum set. In the example shown in FIG. 7, if all of the eight bits are zero, the check results in all the eight directions are faults. In such a case, the flags are set in a central area of the target pixel 304 without shifting the tone.

The 18 tone shifting patterns can be represented by six tone shifting patterns with their tone levels shown in FIG. 7. The controller 220 computes the virtual address of the pixel corresponding to the tone shifting pattern generated by rotating the stored tone shifting pattern, based on the virtual address assigned to the pixel 306 that forms the tone shifting pattern shown in FIG. 6, and sets the flag.

Although the 18 patterns are represented by the 6 patterns in the first embodiment depending on the tone intensity level, there can be a case where the positions of the pixels are not symmetric in the target pixel 304. For example, if the flag is set at a pixel 23 but not at a pixel 20 in FIG. 6, the orientation of the tone shifting pattern can be adjusted by a mirror image method instead of the rotation. In this manner, all of the tone shifting patterns can be represented by eight patterns, with which the virtual address can be computed and the flag can be set.

For example, if the density of the target pixel is 2′b01, the register memory 222 originally stores therein four patterns of “top shift only”, “left shift only”, “top-left shift”, and “no shift”. The controller 220 can set a tone shifting pattern of “bottom shift only” by generating a vertical mirror image of the “top shift only”, and a tone shifting pattern of “right shift only” by generating a horizontal mirror image of the “left shift only”. Furthermore, the controller 220 can set a tone shifting pattern of “top-right shift” by generating a horizontal mirror image of the “top-left shift”, and a tone shifting pattern of “bottom-left shift” by generating a vertical mirror image of the “top-left shift”. Moreover, the controller 220 can set a tone shifting pattern of “bottom-right shift” by rotating the “top-left shift” 180°. In this manner, even if the flags are set asymmetrically, all the required patterns can be generated from the four tone shifting patterns stored in the register memory 222.

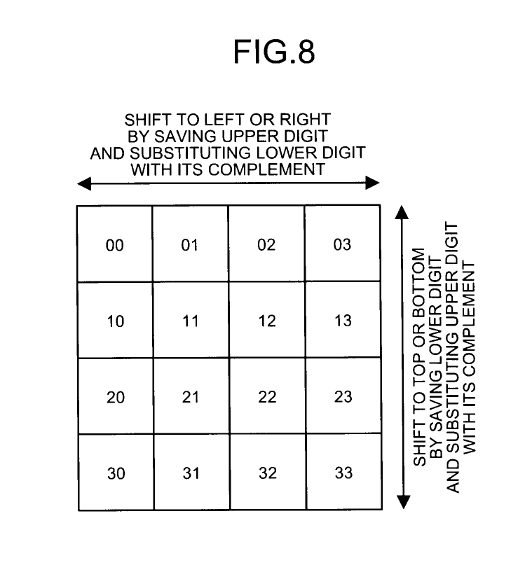

FIG. 8 is a schematic diagram for explaining an n-ary operation process performed in the first embodiment. The n-ary operation process is a subroutine of the computer program executed by the controller 220, and used to rotate the tone shifting patterns. The n-ary operation is performed separately on the upper digit and the lower digit of the quaternary number indicative of the virtual address. A lateral shift of the tone shifting pattern is performed by saving the upper digit of the virtual address and replacing the lower digit with its complement in the n-ary operation. The complement herein is a number that should be added to a predetermined number so that the predetermined number increments to “n−1”. In this case, the complement of zero is three, that of one is two, and that of three is zero.

For example, to shift a pixel 00 to the right, the lower digit of 00 is replaced by the complement of zero, i.e. 3, and the virtual address of the pixel becomes 03. On the contrary, a longitudinal shift is performed by saving the lower digit of the virtual address and replacing the upper digit with its complement in the n-ary operation. The replacement in this process can be performed in various ways. For example, complements are computed, the digit to be saved and the other digit to be replaced are selected, and the digit to be replaced is replaced with its complement. Otherwise, the value of the virtual address to be generated can be directly computed from the values in the upper digit and the lower digit. To reduce a computation load on the controller 220, a shift register or the like can be provided to the controller 220.

In addition to the lateral shift and the longitudinal shift, the n-ary operation enables the rotation of the tone shifting pattern by switching the upper digit with the lower digit. For example, the virtual address 03 is computed from the virtual address 30, thereby rotating the tone shifting pattern 90°. By taking advantage of the n-ary operation, the virtual address equivalent to the rotation of the tone shifting pattern can be efficiently generated.

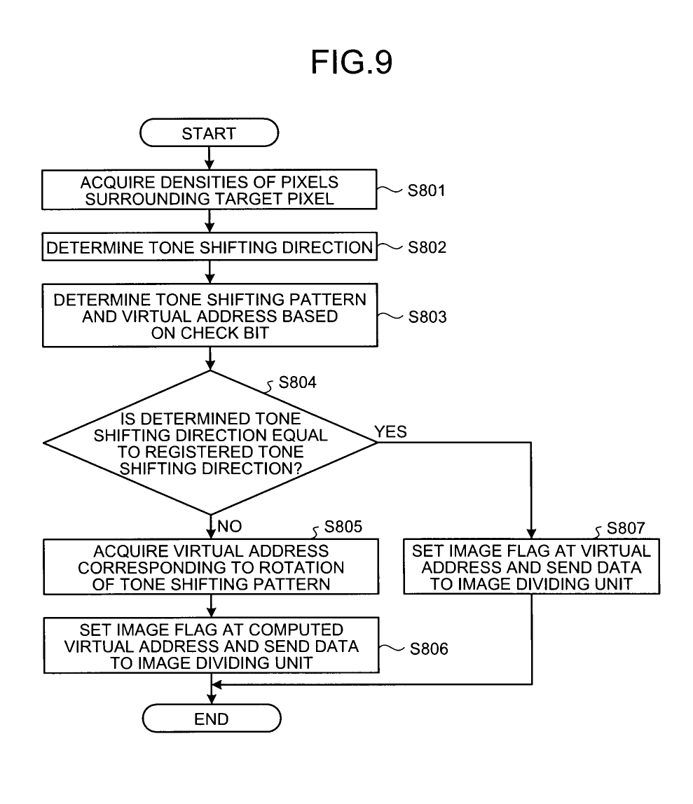

FIG. 9 is a flowchart of the tone shifting process performed by the controller 220. The controller 220 computes the density of the adjacent pixels surrounding the target pixel 304 in the plurality of the main scanning lines, and computes the total of the densities in the rows and the columns (Step S801). The controller 220 compares the total densities in units of the rows and the columns to determine the tone shifting direction, and sets the bit address corresponding to the 8-bit tone-shifting direction data (Step S802).

The controller 220 acquires the check bits from the memory area 606, and the tone shifting pattern specified by the tone-shifting direction data and the virtual address from the memory area 604 (Step S803). At the address of the tone shifting pattern in the memory area 602 of the register memory 222, the flag can be set as default, or the flag can be set in response to the following steps.

The controller 220 determines whether the orientation of the tone shifting pattern stored in the memory area 602 matches the orientation determined by the tone-shifting direction data based on the 8-bit address (Step S804). For example, in the example shown in FIG. 7, the tone shifting patterns in the directions of the top left, the left, and the bottom left are stored. If the tone-shifting direction data matches any one of the stored tone shifting patterns, it means that they match. If the orientations match (YES at Step S804), the controller 220 sets the flag at the real address in the register memory 222 mapped to the virtual address in the memory area 604, and sends the data to the image dividing unit 208 (Step S807).

If the orientations do not match (NO at Step S804), the controller 220 executes the n-ary operation routine using the 8-bit tone-shifting direction data to obtain the virtual address corresponding to the tone-shifting direction data (Step S805). The controller 220 sets the flag at the real address in the register memory 222, which corresponds to the virtual address, and sends the data to the image dividing unit 208 (Step S806).

As described above, the tone shifting pattern required for the tone shifting process with only the minimum set of the tone shifting patterns stored in the register memory 222. Furthermore, because the tone shifting pattern can be generated by the operation within the controller 220 without using a lookup table or the like, the tone shifting process requires the least memory area and the least time. Moreover, a negative impact on a success rate of forming the image can be minimized. Furthermore, because the tone can be shifted in both the main scanning direction and the sub scanning direction, the halftone image quality is not degraded by an isolated dot. Moreover, in the case of a modification on the image shifting pattern, only the corresponding image pattern needs to be modified, thereby reducing cost for maintenance and development. Furthermore, an additional correction of the processing routine according to the increase or the decrease of resolution can be minimized.

In the tone shifting process described above, for better understanding, after the image dividing unit 208 divides the image into nine pixels including the target pixel 304, the controller 220 determines the tone shifting direction based on the densities of the pixels, determines whether the determined tone shifting direction matches the tone shifting patterns stored in the register memory 222, and sets the flag at the virtual address. However, the steps are not necessarily performed in the temporal order as described above. For example, when the controller 220 determines the tone shifting pattern and the virtual address at Step S803, the controller 220 selects one of the tone shifting patterns that is identical to or similar to the determined tone shifting pattern from the register memory 222, sets the flag at the virtual address corresponding to the selected tone shifting image, a rotated image of the selected tone shifting image, or a mirrored image of the selected tone shifting image at the same time.

According to a second embodiment of the present invention, the register memory 222 stores therein an address assignment table that includes addresses of all of the 18 tone shifting patterns as the lookup table. To rotate the tone shifting pattern, the controller 220 acquires a set of the stored tone shifting pattern and an address specified by the tone-shifting direction data from the address assignment table to set the flag at the obtained address. According to the second embodiment, the register memory 222 needs to spare more memory area, modification of the tone shifting pattern is more complicated, and a lookup process needs to be performed two times; however, the second embodiment can be used when the throughput rate is acceptable and when the tone shifting pattern is generated for a specific image forming apparatus.

According to a third embodiment of the present invention, the register memory 222 stores therein the minimum number of the tone shifting patterns and a lookup table including all of the real addresses that form the tone shifting patterns. In this case, the tone shifting image is rotated around an axis specified by the tone-shifting direction data based on the two-dimensional rotating matrix, and coordinates assigned to the pixels 306 are compared with one another. According to the third embodiment, the flag is set at the real address of the pixel obtained by the comparison of the coordinates.

According to the third embodiment, the lookup table including the tone shifting patterns, the pixels that form the tone shifting patterns, and the real addresses assigned to the pixels. By assigning the coordinates to the pixels 306 and generating a lookup table including the addresses of the pixels in rotated tone shifting patterns, the controller 220 can set the flag at the real address corresponding to the rotated tone shifting pattern. According to the third embodiment, and an additional lookup table is required, and the rotating operation needs to be performed with respect to each pixel, which requires an increased amount of computing; however, the two-dimensional tone-shifting is possible using the minimum number of the tone shifting patterns.

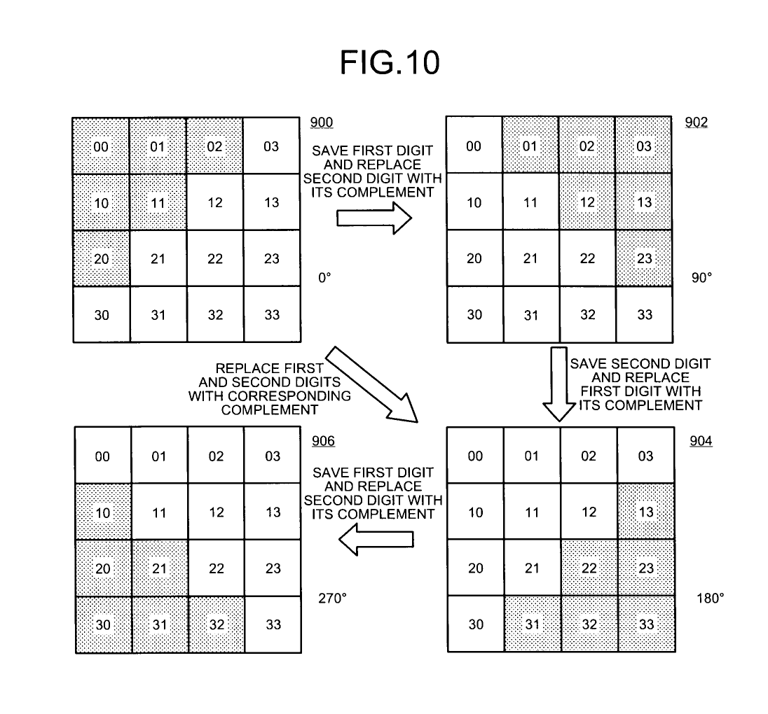

FIG. 10 is a schematic diagram for explaining a relation between rotation of the tone shifting pattern and assignment of the virtual address at which the flag is set. By replacing the lower digit of the virtual address assigned to each of the pixels in a stored tone shifting pattern 900 with its complement, a virtual address corresponding to a tone shifting pattern 902, which is equal to a 90° rotated tone shifting pattern 900, is obtained. By replacing the upper digit of the virtual address in the tone shifting pattern 902 with its complement, a virtual address corresponding to a tone shifting pattern 904, which is equal to a 180° rotated tone shifting pattern 900, is obtained.

By further replacing the lower digit of the virtual address in the tone shifting pattern 904 with its complement, a virtual address corresponding to a tone shifting pattern 906, which is equal to a 270° rotated tone shifting pattern 900, is obtained. By replacing both the lower digit and the upper digit of the virtual address in the tone shifting pattern 900 with their complements, the virtual address corresponding to the tone shifting pattern 904 is obtained in a single operation.

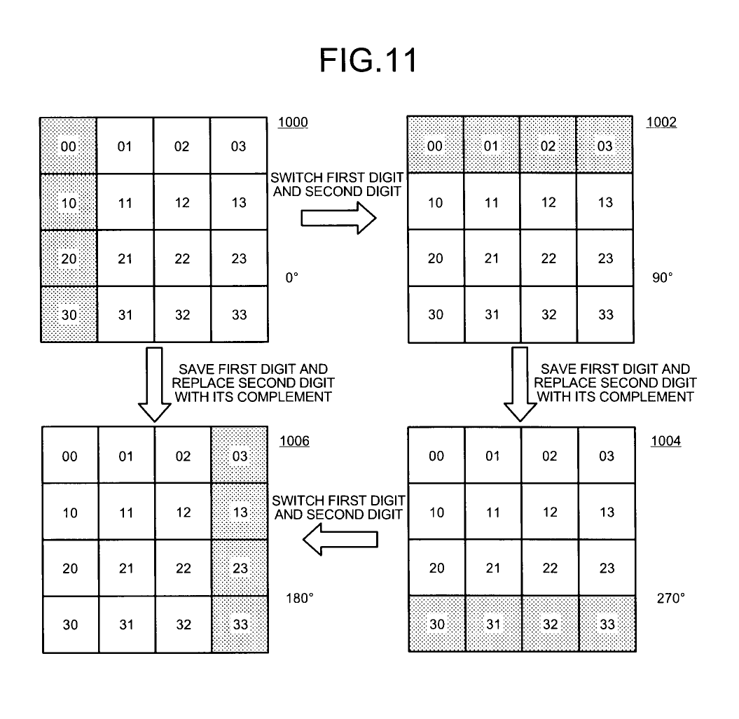

FIG. 11 is a schematic diagram for explaining another example of the relation between the rotation of the tone shifting pattern and the assignment of the virtual address at which the flag is set. By replacing the upper digit of the virtual address in a stored tone shifting pattern 1000 with its lower digit, a virtual address corresponding to a tone shifting pattern 1002, which is equal to a 90° rotated tone shifting pattern 1000, is obtained. By replacing the upper digit of the virtual address in the tone shifting pattern 1002 with its complement, a virtual address corresponding to a tone shifting pattern 1004, which is equal to a 270° rotated tone shifting pattern 1000, is obtained. By further replacing the upper digit of the virtual address in the tone shifting pattern 1004 with its lower digit, a virtual address corresponding to a tone shifting pattern 1006, which is equal to a 180° rotated tone shifting pattern 1000, is obtained.

The n-ary operation performed in the above processes can be easily configured as a subroutine or the like. Furthermore, a sequence of loading the subroutine can be changed at any time to increase computational efficiency. Moreover, although the quaternary numeral system is used in the processes shown in FIGS. 10 and 11, binary numeral system can be used by performing the same operations on pairs of the upper two digits and the lower two digits. Furthermore, as song as a pixel is divided by a positive integer, if the dividing number, i.e. the resolution or the number of the laser beams, is changed, the dividing number can be corrected only by reassigning virtual address in the same manner.

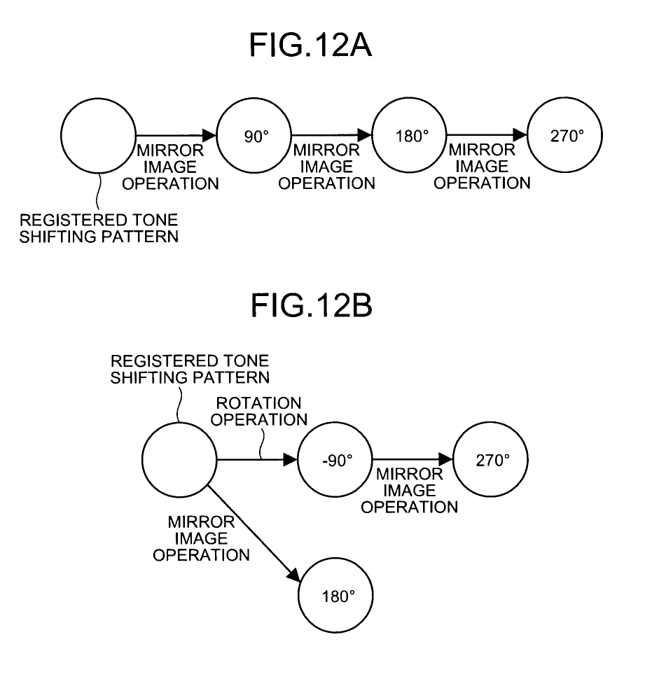

FIGS. 12A and 12B are sequence diagrams of n-ary operation routines performed in the processes shown in FIGS. 10 and 11, respectively. Hereinafter, an operation of replacing either digit with its complement is referred to as a mirror image operation, and an operation of replacing the upper digit with the lower digit is referred to as a rotation operation.

In FIG. 12A, the tone shifting pattern is rotated by 90° by performing the mirror image operation on the lower digit, and a 180°-rotated tone shifting pattern is obtained by further performing the mirror image operation on the upper digit. By further performing the mirror image operation on the lower digit, a 270°-rotated tone shifting pattern is obtained.

In FIG. 12B, by performing the rotation operation, the tone shifting image is rotated by 90°. By further performing the mirror image operation on the lower digit, the 270°-rotated tone shifting pattern is obtained. On the other hand, by performing the mirror image operation on the lower digit of the stored tone shifting pattern, the 180°-rotated tone shifting pattern is obtained.

In the above embodiments, increase of the number of the laser beams per unit area enables to two-dimensionally shift the dots in both the main scanning direction and the sub scanning direction.

Furthermore, as the dots become finer, the image forming apparatus 100 shifts the dots in both the main scanning direction and the sub scanning direction to form an image. The shift of the dots is performed by checking the density of eight adjacent pixels surrounding the target pixel 304 and generating a pattern of the dots that form the target pixel 304.

Moreover, to generate the pattern of the dots faster and more efficiently, a minimum set of the tone shifting patterns is stored in the register memory 222, and any one of other tone shifting patterns is obtained by rotating one of the tone shifting patterns stored in the register memory 222.

Furthermore, the VCSEL can be used as the semiconductor laser, which can emit a plurality of laser beams in both the main scanning direction and the sub scanning direction. In this manner, the dots can be shifted in the both directions, thereby enabling the optimal shift of the dots.

Moreover, because the operation is switched between the black or white pixel and the halftone pixel, the controller 220 is not burdened with an excessive load and the throughput rate of the image forming is not reduced.

The functions explained above are described in an assembler language and stored in a ROM, an EPROM, or an electrically erasable read only memory (EEPROM) incorporated in or connectable to a microcomputer using a ROM writer or the like.

According to an aspect of the present invention, degradation of the image quality caused by an isolated dot can be prevented, and a super fine image with high quality can be efficiently provided. Furthermore, the degradation of the image quality caused by an isolated dot can be prevented regardless of the orientation of the image.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a dividing unit that divides image data that is formed with a plurality of pixels each including an image dot in a main scanning direction and a sub scanning direction in units of pixel, and divides a target pixel, which is a pixel to be corrected from among divided pixels, into a plurality of image blocks including a plurality of image dots; and
a correcting unit that corrects the image dots of the image blocks, based on contrast of densities of adjacent pixels adjacent to the target pixel, by shifting the image dots in a density direction that is a direction toward an adjacent pixel having a higher density.

2. The image processing apparatus according to claim 1, further comprising a pattern storing unit that stores therein pattern pixels fewer than number of the adjacent pixels, in which a direction to shift the image dots of the image blocks is defined in units of image block, wherein
the correcting unit corrects the image dots of the image blocks by shifting the image dots in the density direction in units of image block based on the image dots defined in the pattern pixels.

3. The image processing apparatus according to claim 1, wherein the correcting unit sums up densities of the adjacent pixels in the main scanning direction and the sub scanning direction, and determines a direction of the adjacent pixels with a largest sum of densities as the density direction.

4. The image processing apparatus according to claim 2, wherein,
the correcting unit sums up densities of the adjacent pixels in the main scanning direction and the sub scanning direction, and determines a direction of the adjacent pixels with a largest sum of densities as the density direction, and
when a determined density direction does not match with the direction to shift the image dots of the image blocks defined in the pattern pixels, the correcting unit selects a pattern pixel that satisfies the density direction from among the pattern pixels.

5. The image processing apparatus according to claim 4, wherein
the correcting unit determines whether the density of the target pixel is halftone, and when it is determined that the density of the target pixel is halftone, selects a pattern pixel that satisfies the density direction from among the pattern pixels.

6. The image processing apparatus according to claim 2, wherein
the pattern storing unit further stores therein an address of a position where the image dot is written, in association with the image block, and
the correcting unit calculates a virtual address corresponding to the address based on base n number, where n is number of image blocks, and corrects an image dot written in an image block of a calculated virtual address by shifting the image dot in the density direction.

7. The image processing apparatus according to claim 6, wherein the correcting unit calculates the virtual address by replacing the base n number with its complement.

8. The image processing apparatus according to claim 1, further comprising a semiconductor laser that emits a laser light to form the image dot.

9. The image processing apparatus according to claim 7, wherein the semiconductor laser is a vertical cavity surface emitting laser.

10. An image processing apparatus comprising:
a reading unit that reads an original, and generates image data that is formed with a plurality of pixels each including an image dot;
a dividing unit that divides the image data in a main scanning direction and a sub scanning direction in units of pixel, and divides a target pixel, which is a pixel to be corrected from among divided pixels, into a plurality of image blocks including a plurality of image dots; and
a correcting unit that corrects the image dots of the image blocks, based on contrast of densities of adjacent pixels adjacent to the target pixel, by shifting the image dots in a density direction that is a direction toward an adjacent pixel having a higher density.

11. An image processing method comprising:
dividing image data that is formed with a plurality of pixels each including an image dot in a main scanning direction and a sub scanning direction in units of pixel, and divides a target pixel, which is a pixel to be corrected from among divided pixels, into a plurality of image blocks including a plurality of image dots; and
correcting the image dots of the image blocks, based on contrast of densities of adjacent pixels adjacent to the target pixel, by shifting the image dots in a density direction that is a direction toward an adjacent pixel having a higher density.
